(19) United States
(12) Patent Application Publication
(10) Pub. No.: US 2013/0227759 A1
(43) Pub. Date: Sep. 5, 2013

(54) Fabrics Containing a Blend of Polyarylene Sulfide and Textile Fibers

(71) Applicant: TICONA LLC, Florence, KY (US)

(72) Inventors: Harrie P. Schoots, Houston, TX (US); Kaushik Chakrabarty, Florence, KY (US); Xinyu Zhao, Cincinnati, OH (US); Arvind Karandikar, Morristown, TN (US); Martin Brueck, Weilrod (DE); Christopher McGrady, Florence, KY (US)

(73) Assignee: TICONA LLC, Florence, KY (US)

(21) Appl. No.: 13/773,707

(22) Filed: Feb. 22, 2013

Related U.S. Application Data
(60) Provisional application No. 61/605,338, filed on Mar. 1, 2012.
(60) Provisional application No. 61/614,134, filed on Mar. 22, 2012.

(51) Int. Cl. D06P 3/00; A62B 17/00; D06M 13/03

(52) U.S. Cl. CPC D06P 3/004; D06M 13/03; A62B 17/00
USPC 2/93; 442/164; 442/152; 442/155; 442/168; 442/169; 442/165; 8/495

(57) ABSTRACT

A fabric that contains a blend of textile and polyarylene sulfide fibers is provided. At least a portion of the textile fibers, polyarylene sulfide fibers, or a combination thereof are coated with an emulsion copolymer that is crosslinked. The copolymer composition is cured after it is applied to the fibers to initiate the formation of crosslink bonds between the emulsion copolymer and create a three-dimensional network that is capable of coating and encapsulating the fibers. It is believed that this three-dimensional network is able to physically entrap disperse additives when applied to the fibers. Still further, the present inventors have discovered that the emulsion copolymer can uniformly coat the fibers and thus readily receive the additive, which eliminates the need for high temperatures and/or pressures during a dyeing process, for example, and can also result in a relatively uniform coating of the additive on the fibers.

### RELATED APPLICATIONS

The present application claims priority to U.S. Provisional Application Ser. Nos. 61/605,338 (filed on Mar. 1, 2012) and 61/614,134 (filed on Mar. 22, 2012), which are incorporated herein in their entirety by reference thereto.

### BACKGROUND OF THE INVENTION

Polyphenylene sulfide (“PPS”) is a high performance polymer that can withstand high thermal, chemical, and mechanical stresses. In many applications (e.g., garments, clothing, etc.), it is desirable to employ PPS fibers in combination with cellulosic fibers (e.g., cotton, wool, rayon, etc.) to help achieve a fabric that combines the performance of the PPS fibers with the softness, texture, etc. of the cellulosic fibers. One drawback to such blended materials is that the PPS fibers cannot be dyed using conventional dyes because the polymer lacks available binding sites. Even if suitable dyes were available, however, attempts at coloring other types of high performance fibers have generally required the use of extreme processing conditions, which are expensive and inefficient. For example, dyeing liquors can be formed that contain a disperse dye in an aqueous solution. In many cases, such liquors are kept at an elevated temperature (e.g., 170° C. to 260° C.) and pressure in an attempt to facilitate the transfer of the dye to the high performance fibers. Even at such a high temperature and pressure, however, any dye that may have even been absorbed by the fibers is easily removed by washing and readily faded by light. Furthermore, light stabilizers, which are often employed to improve the lightfastness of the dye, can also be easily removed and degraded by light.

As such, a need exists for a fabric that can effectively incorporate a blend of polyarylene sulfide and textile fibers (e.g., cellulosic fibers).

### SUMMARY OF THE INVENTION

In accordance with one embodiment of the present invention, a fabric is disclosed that comprises textile fibers and polyarylene sulfide fibers formed from at least one polyarylene sulfide. An emulsion copolymer is disposed on the textile fibers, polyarylene sulfide fibers, or a combination thereof. The emulsion copolymer contains two or more ethylenically unsaturated monomeric units and is cured so as to form a three-dimensional crosslinked network that coats the fibers.

In accordance with yet another embodiment of the present invention, a method is disclosed for dyeing a fabric that comprises textile fibers and polyarylene sulfide fibers formed from at least one polyarylene sulfide. The method comprises contacting the fabric with an aqueous emulsion comprising a copolymer that contains two or more ethylenically unsaturated monomeric units; curing the emulsion copolymer to form a three-dimensional crosslinked network that coats the textile fibers and the polyarylene sulfide fibers; and immersing the fabric in a bath that contains a disperse dye.

Other features and aspects of the present invention are set forth in greater detail below.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a fabric (e.g., nonwoven fabric, knitted fabric, woven fabric, etc.) that contains a blend of textile fibers and polyarylene sulfide fibers. At least a portion of the textile fibers, polyarylene sulfide fibers, or a combination thereof are coated with an emulsion copolymer that is crosslinked. For example, the copolymer may contain a reactive co-monomer that acts as a crosslinking agent. Alternatively, a separate crosslinking agent may be combined with the emulsion copolymer. In either case, the resulting copolymer composition is cured after it is applied to the fibers to initiate the formation of crosslink bonds between the emulsion copolymer and create a three-dimensional network that is capable of coating and encapsulating the fibers. Without intending to be limited by theory, it is believed that this three-dimensional network is able to physically entrap a disperse additive (e.g., disperse dyes, light stabilizers, etc.) when applied to the fibers. In this manner, even when the fibers are later washed or exposed to light (e.g., ultraviolet light), the additive can still remain affixed to the fibers and provide the desired crockfastness, light fastness, and UV stability. Still further, the present inventors have discovered that the emulsion copolymer can uniformly coat the fibers and thus readily receive the additive. This ability to readily receive the additive eliminates the need for high temperatures and/or pressures during application of the additive, and can also result in a relatively uniform coating of the additive on the fibers. Thus, as indicated above, the present inventors have discovered that the unique crosslinked emulsion copolymer coating is able to allow polyarylene sulfide fibers to receive certain types of additives (e.g., dyes), which was previously thought to not be possible.

Various embodiments of the present invention will now be described in more detail.

### I. Fabric

The textile and polyarylene fibers of the fabric may be in the form of individual staple fibers or filaments (continuous fibers), or yarns containing multiple staple fibers or filaments. Yarns may include, for instance, multiple staple fibers that are twisted together (“spun yarn”), filaments laid together without twist (“zero-twist multi-filament yarn”), filaments laid together with a degree of twist (“twisted multi-filament yarn”), a single filament with or without twist (“monofilament”), etc. The staple fibers or filaments in the yarn can be formed from the same or different type of material. For example, a multi-filament yarn may contain polyarylene sulfide filaments and textile fiber filaments. Alternatively, the fabric may contain one set of yarns (e.g., warp directional yarns) containing polyarylene sulfide fibers and another set of yarns (e.g., weft directional yarns) formed substantially from textile fibers. The emulsion copolymer can be coated onto any portion of the fibers used in the fabric, including the textile fibers and/or the polyarylene sulfide fibers. In one embodiment, for example, the fabric is a woven fabric containing warp and weft yarns. In certain embodiments, the emulsion copolymer is coated onto the fibers of both types of yarns. While not all of the yarns need to be treated, at least about 20%, and in some embodiments, at least about 40% of the fibers in the warp and/or weft yarns may be coated. In certain cases, one type of yarn (e.g., weft yarn) may completely lack the emulsion copolymer coating.

A. Textile Fibers

Various textile fibers may be employed in the fabric of the present invention. Particularly suitable textile fibers are natural fibers, such as cotton, wool, bast, silk, etc., and/or synthetic fibers, such as aromatic polyamides (e.g., meta-aramids (e.g., Nomex® or Kevlar®), para-aramids, etc.), aliphatic polyamides (e.g., nylon), polyesters, polybenzimidazole (“PBI”), polybenzoxazole (“PBO”), polypyridobisimidazole (“PIPD”), rayon, melamine, acetate, lyocell, etc., as well as combinations of two or more types of natural and/or synthetic fibers. Cellulosic fibers, such as cotton, rayon, or lyocell fibers, may be particularly suitable. In one particular embodiment of the present invention, the textile fibers are in the form of cotton yarns, which can refer to a double or multi-stranded filaments made by twisting or otherwise bonding cotton staple fibers together to make a cohesive thread. Twisting fibers into yarn is, of course, the process called spinning. The cotton fibers can be spun into yarn in the form of single ply or multi-plied yarns. Cotton fibers that form such yarns typically range from about 1.0 to about 3.0 denier per filament (dpf) and have a staple length range of from about 8.0 cm. When incorporated into a woven fabric, cotton yarn may be in the warp direction (“warp yarn”) and/or weft direction (“weft yarn”).

B. Polyarylene Sulfide Fibers

The polyarylene sulfide fibers are generally formed from at least one polyarylene sulfide, which is generally able to withstand relatively high temperatures without melting. The polyarylene sulfide(s) generally have repeating units of the formula:

—[(Ar¹)ₙ—X]ₘ—[(Ar²)ᵢ—Y]ⱼ—[(Ar³)ₖ—Z]ₗ-[(Ar⁴)ₒ—W]ₚ—

wherein,

Ar¹, Ar², Ar³, and Ar⁴ are independently arylene units of 6 to 18 carbon atoms;

W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —5—; and n, m, i, j, k, I, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthylene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1 ,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

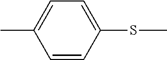

and segments having the structure of formula:

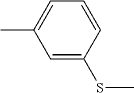

or segments having the structure of formula:

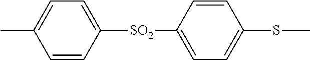

In another embodiment, a polyarylene sulfide copolymer may be formed that includes a first segment with a number-average molar mass Mn of from 1000 to 20,000 g/mol. The first segment may include first units that have been derived from structures of the formula:

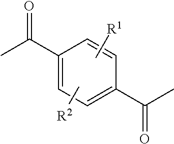

where the radicals R¹ and R², independently of one another, are a hydrogen, fluorine, chlorine or bromine atom or a branched or unbranched alkyl or alkoxy radical having from 1 to 6 carbon atoms; and/or second units that are derived from structures of the formula:

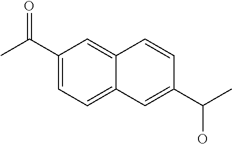 [SMILES: CC(=O)c1ccc2cc(C(C)O)ccc2c1]

The first unit may be p-hydroxybenzoic acid or one of its derivatives, and the second unit may be composed of 2-hydroxynaphthalene-6-carboxylic acid. The second segment may be derived from a polyarylene sulfide structure of the formula:

—[Ar—S]_{q}—
where Ar is an aromatic radical, or more than one condensed aromatic radical, and q is a number from 2 to 100, in particular from 5 to 20. The radical Ar may be a phenylene or naphthylene radical. In one embodiment, the second segment may be derived from poly(m-thiophenylene), from poly(o-thiophenylene), or from poly(p-thiophenylene).

The polyarylene sulfide(s) may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trinnethylbenzene, 2,2′,4,4′-tetrachlorobiphenyl, 2,2′,5,5′-tetra-iodobiphenyl, 2,2′,6,6′-tetrabrorno-3,3′,5,5′-tetramethylbiphenyl, 1,2,3,4-tetrachloronaphthalene, 1,2,4-tribromo-6-methylnaphthalene, etc., and mixtures thereof.

Regardless of the particular structure, the number average molecular weight of the polyarylene sulfide is typically about 15,000 g/mol or more, and in some embodiments, about 30,000 g/mol or more. In certain cases, a small amount of chlorine may be employed during formation of the polyarylene sulfide. Nevertheless, the polyarylene sulfide will still have a low chlorine content, such as about 1000 ppm or less, in some embodiments about 900 ppm or less, in some embodiments from about 1 to about 800 ppm, and in some embodiments, from about 2 to about 700 ppm. In certain embodiments, however, the polyarylene sulfide is generally free of chlorine or other halogens,

The polyarylene sulfide fibers may be monocomponent fibers that are generally formed from'a polyarylene sulfide or blend of a polyarylene sulfide with an additional polymer but extruded from a single extruder. The additional polymer may include, for instance, polyolefins, aromatic polyesters, aliphatic polyesters, etc. In such fibers, polyarylene sulfide(s) typically constitute from about 30 wt. % to about 95 wt. %, in some embodiments from about 35 wt. % to about 90 wt. %, and in some embodiments, from about 40 wt. % to about 80 wt. % of the fiber. Likewise, the polyarylene sulfide fibers may also be multicomponent fibers (e.g., bicomponent fibers) formed from polyarylene sulfide and at least one additional polymer, which are extruded from separate extruders but spun together to form the fiber. Such multicomponent fibers may have a variety of configurations, such as sheath/core, side-by-side, island-in-the-sea, etc. In a sheath/core configuration, for example, a distinct zone of a first polymer component is surrounded by a distinct zone of a second polymer component. Typically, the second polymer component includes polyarylene sulfide(s), which may constitute from about 30 wt. % to about 95 wt. %, in some embodiments from about 35 wt. % to about 90 wt. %, and in some embodiments, from about 40 wt. % to about 80 wt. % of the second component and/or the entire fiber.

Although the actual amount may vary depending on desired application, polyarylene sulfide(s) typically constitute from about 30 wt. % to about 95 wt. %, in some embodiments from about 35 wt. % to about 90 wt. %, and in some embodiments, from about 40 wt. % to about 80 wt. % of the polyarylene sulfide fibers.

In addition to the polymers described above, the polyarylene sulfide fibers may also contain a variety of other different components to help improve the overall properties. In one embodiment, for example, an organosilane coupling agent may be employed to help improve the mechanical properties. The coupling agent may, for example, be any alkoxysilane coupling agent as is known in the art, such as vinlyalkoxysilanes, epoxyalkoxysilanes, aminoalkoxysilanes, mercaptoalkoxysilanes, and combinations thereof. Aminoalkoxysilane compounds typically have the formula: R⁵—Si—(R⁶)₃, wherein R⁵ is selected from the group consisting of an amino group such as NH₂; an aminoalkyl of from about 1 to about 10 carbon atoms, or from about 2 to about 5 carbon atoms, such as aminomethyl, aminoethyl, aminopropyl, aminobutyl, and so forth; an alkene of from about 2 to about 16 carbon atoms, or from about 2 to about 5 carbon atoms, such as ethylene, propylene, butylene, and so forth; and an alkyne of from about 2 to about 10 carbon atoms, or from about 2 to about 5 carbon atoms, such as ethyne, propyne, butyne and so forth; and wherein R⁶ is an alkoxy group of from about 1 to about 10 atoms, or from about 2 to about 5 carbon atoms, such as methoxy, ethoxy, propoxy, and so forth. In one embodiment, R⁵ is selected from the group consisting of aminomethyl, aminoethyl, aminopropyl, ethylene, ethyne, propylene and propyne, and R⁶ is selected from the group consisting of methoxy groups, ethoxy groups, and propoxy groups. In another embodiment, R⁵ is selected from the group consisting of an alkene of from about 2 to about 10 carbon atoms such as ethylene, propylene, butylene, and so forth, and an alkyne of from about 2 to about 10 carbon atoms such as ethyne, propyne, butyne and so forth, and R⁶ is an alkoxy group of from about 1 to about 10 atoms, such as methoxy group, ethoxy group, propoxy group, and so forth. A combination of various aminosilanes may also be included in the mixture.

Some representative examples of aminosilane coupling agents that may be included in the mixture include aminopropyl triethoxysilane, aminoethyl triethoxysilane, aminopropyl trimethoxysilane, aminoethyl trimethoxysilane, ethylene trimethoxysilane, ethylene triethoxysilane, ethyne trimethoxysilane, ethyne triethoxysilane, aminoethylaminopropyltrimethoxysilane, 3-aminopropyl triethoxysilane, 3-aminopropyl trimethoxysilane, 3-aminopropyl methyl dimethoxysilane or 3-aminopropyl methyl diethoxysilane, N-(2-aminoethyl)-3-aminopropyl trimethoxysilane, N-methyl-3-aminopropyl trimethoxysilane, N-phenyl-3-aminopropyl trimethoxysilane, bis(3-aminopropyl) tetramethoxysilane, bis(3-aminopropyl) tetraethoxy disiloxane, and combinations thereof. The amino silane may also be an aminoalkoxysilane, such as γ-aminopropyltrimethoxysilane, γ-aminopropyltriethoxysilane, γ-aminopropylmethyldimethoxysilane, γ-aminopropylmethyldiethoxysilane, N-((3-aminoethyl)-γ-aminopropyltrimethoxysilane, N-phenyl-γ-aminopropyltrimethoxysilane, γ-diallylaminopropyltrimethoxysilane and γ-diallylanninopropyltrimethoxysilane. One suitable aminosilane is 3-aminopropyltriethoxysilane, which is available from Degussa, Sigma Chemical Company and Aldrich Chemical Company.

Fillers, such as mineral fillers, may also be employed to help achieve the desired properties. When employed, such mineral fillers typically constitute from about 5 wt. % to about 60 wt. %, in some embodiments from about 10 wt. % to about 50 wt. %, and in some embodiments, from about 15 wt. % to about 45 wt. % of the fibers. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂,(H₂O)]), montmorillonite (Na,Ca)_{0.33}(Al,Mg)₂Si₄O₁₀(OH)₂·nH₂O), vermiculite ((MgFe,Al)₃(Al,Si)₄O₁₀(OH)₂·4H₂O), palygorskite ((Mg,Al)₂Si₄O₁₀(OH)·4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be a particularly suitable mineral for use in the present invention. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

Lubricants may also be employed that are capable of withstanding the processing conditions of poly(arylene sulfide) (typically from about 290° C. to about 320° C.) without substantial decomposition. Exemplary of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N″-ethylenebissteararnide. When employed, the lubricant(s) typically constitute from about 0.05 wt. % to about 1.5 wt. %, and in some embodiments, from about 0.1 wt. % to about 0.5 wt. % of the fibers.

Any of a variety of different techniques may generally be employed to form polyarylene sulfide fibers as is well known in the art, such as described in U.S. Pat. Nos. 4,816,335 to Kouyama, et al.; 5,178,813 to Akatsu, et al.; 5,372,760 to Wellenhofer, et al. and 7,931,843 to Krins, et al. For example, a polyarylene sulfide composition may be extruded through a spinneret, quenched, and drawn into a fiber draw unit. In one particular embodiment, a polyarylene sulfide composition may be fed into an extruder from a hopper. The extruded composition can pass through a polymer conduit to a spinneret through which the fibers are melt spun. A quench blower may also be positioned adjacent the fibers extending from the spinneret that supplies air to quench the fibers. After quenching, the fibers may be drawn into a fiber draw unit, which may include an elongated vertical passage through which the fibers are drawn by aspirating air entering from the sides of the passage and flowing downwardly through the passage. The drawing or attenuation of the fibers can increase the molecular orientation or crystallinity of the polymer. The draw ratio may, for example, range from about 2:1 to about 15:1, in some embodiments from about 3:1 to about 10:1, and in some embodiments, from about 4:1 to about 6:1. After stretching, the fibers can optionally be heat-treated to enhance dimensional stability and crystallization. Such heat treatment may occur, for instance, at a temperature of from about 200° C. to about 280° C.

### II. Emulsion Copolymer Coating

As indicated above, the emulsion copolymer may be coated onto textile fibers and/or polyarylene sulfide fibers. The emulsion copolymer generally contains two or more monomeric units selected from the group consisting of vinyl esters (e.g., vinyl esters of acetic acid (“vinyl acetate”), vinyl esters of neoalkanoic acids, etc.); α-olefins (e.g., ethylene, propylene, α-butylene, α-pentylene, α-hexylene, α-octylene, etc.; acrylic esters (e.g., acrylate, methacrylate, alkyl acrylate, alkyl methacrylate, etc.); styrenes (e.g., styrene, methyl styrene, etc.), conjugated dienes (e.g., butadiene, hexadiene, etc,); halogenated compounds (e.g., vinyl chloride, vinylidene chloride, chloroprene, chiorostyrene, etc.); acrylonitrile, etc., as well as combinations thereof. Specific examples of suitable copolymers may include, for instance, vinyl acetate copolymers (e.g., vinyl acetate/ethylene copolymers), vinyl acetate/acrylic copolymers, vinyl acetate/vinyl versatate copolymers, vinyl chloride/vinyl acetate/ethylene copolymers, etc.); vinyl chloride copolymers (e.g., vinyl chloride/α-olefin copolymers); acrylic copolymers (e.g., acrylic ester copolymers, styrene-acrylic copolymers, alkyl acrylate/acrylonitrile copolymers), and so forth, as well as combinations of the foregoing. Such copolymers may also include other monomeric units, such as crosslinkable co-monomers, which are described in more detail below.

In one particular embodiment, for example, the copolymer is an “acrylic ester” copolymer that contains acrylic ester monomeric units, such as alkyl acrylates and/or methacrylates containing from 1 to 12, and in some embodiments, from 1 to 10 carbon atoms in the alkyl group. The polymer backbone in the acrylic ester copolymer can be either hydrophilic or hydrophobic and it can comprise polymerized soft monomers (glass transition temperature below 50° C.) and/or hard monomers (e.g., glass transition temperature above 50° C.). Particularly suitable “soft” acrylic ester monomers are alkyl acrylates containing 2 to 8 carbon atoms in the alkyl group and include ethyl acrylate, propyl acrylate, n-butyl acrylate, and 2-ethylhexyl acrylate. The copolymer may, for example, contain “soft” acrylic ester monomeric substituents (e.g., ethyl acrylate, butyl acrylate, or both) in an amount of from about 50 wt. % to about 99 wt. %, in some embodiments from about 70 wt. % to about 99 wt. %, and in some embodiments, from about 80 wt. % to about 98 wt. %, based on the total monomers employed. If desired, the “acrylic ester” copolymer may also contain “hard” monomers such as alkyl methacrylates containing from 1 to 3 carbon atoms in the alkyl group, acrylonitrile, vinyl chloride, etc. Such “hard” monomers may, for example, constitute from about 1 wt. % to about 15 wt. %, in some embodiments from about 2 wt. % to about 12 wt. %, and in some embodiments, from about 4 wt. % to about 10 wt. %, based on the total monomers employed in the copolymer.

In yet another embodiment of the present invention, the emulsion copolymer is a “vinyl ester” copolymer that contains vinyl ester monomeric units (e.g., vinyl acetate) in an amount of from about 60 wt. % to about 99 wt. %, in some embodiments from about 70 wt. % to about 95 wt. %, and in some embodiments, from about 80 wt. % to about 95 wt. %, based on the total monomers employed. The “vinyl ester” copolymer may also contain other monomeric units, such as α-olefins (e.g., ethylene), acrylates (e.g., alkyl acrylates), etc. For instance, in certain embodiments, the “vinyl ester” copolymer may contain α-olefin monomeric units (e.g., ethylene) in an amount of from about 1 wt. % to about 30 wt. %, in some embodiments from about 2 wt. % to about 20 wt. %, and in some embodiments, from about 4 wt. % to about 10 wt. %, based on the total monomers employed therein.

As indicated above, the emulsion copolymer may also contain co-monomers that are capable of undergoing a reaction with a functional group present on the copolymer to form a crosslinked network. When employed, such crosslinking co-monomers may constitute from about 0.1 wt. % to about 10 wt. %, in some embodiments from about 0.5 wt. % to about 8 wt. %, and in some embodiments, from about 1 wt. % to about 6 wt. % of the polymer based on the total monomers employed. The crosslinking co-monomers may be ethylenically unsaturated so that they can readily polymerize into the copolymer backbone. The co-monomers may also be functionalized to the extent that they contain at least one heteroatom, such as nitrogen, oxygen, silicon, etc., as well as combinations thereof. For instance, suitable ethylenically unsaturated co-monomers may contain least one amide, epoxy, or alkoxysilane group. Specific examples of such co-monomers include, for instance, acrylamides, such as N-methylolacrylamide (NMA), N-methylolmethacrylamide, diacetoneacrylamide, etc., as well as esters or ethers thereof, such as isobutoxy ethers or esters of N-methylolacrylamide, of N-methylolmethacrylamide. Also suitable are epoxide-functional co-monomers, such as glycidyl methacrylate, glycidyl acrylate, allyl glycidyl ether, vinyl glycidyl ether, etc. Further examples are silicon-functional co-monomers, such as acryloxy-propyltri(alkoxy)silanes and methacryloxy-propyltri(alkoxy)silanes, vinyltrialkoxysilanes and vinylmethyldialkoxysilanes, with alkoxy groups which can be present being, for example, methoxy, ethoxy and ethoxypropylene glycol ether radicals. Yet other suitable crosslinking co-monomers have hydroxy and/or carboxyl groups, such as hydroxyalkyl methacrylates and acrylates (e.g., hydroxyethyl, hydroxypropyl or hydroxybutyl acrylate or methacrylate), acetylacetoxyethyl acrylate or methacrylate, dimethylarninoethyl acrylate, etc.

In addition to or in lieu of crosslinking co-monomers, external crosslinking agents may also be employed, such as epoxysilanes, bisulfites, ammonium salts, zirconium salts, glyoxals, boric acid, dimethyloldihydroxyethyleurea, etc. Suitable external crosslinking agents may also include phenol formaldehyde resins, resorcinol formaldehyde resins, melamine formaldehyde resins, hydroxymethylsubstituted imidazolidinones or thioimidazolidinones, hydroxymethyl substituted pyrimidinones or hydroxymethyl substituted triazinones or glycoluriles or their self-condensation products are suitable or mixed condensates from two or more of the compounds mentioned, or a mixture from two or more of the compounds mentioned. When employed, such crosslinking agents are typically combined with the copolymer after it is formed.

The emulsion copolymer of the present invention may be synthesized using a variety of known techniques including by bulk, solution, suspension and emulsion processes as is described in the Kirk-Othmer Encyclopedia of Chemical Technology, 4^{th} Ed Vol. 24, pp. 954-963 (Wiley 1996). The preparation of such polymers can be carried out using continuous or discontinuous processes of free-radical emulsion polymerization. The polymerization may be conducted with the assistance of customary reaction vessels such as loop or stirred reactors. Preference is given to using discontinuous processes such as batch, combined batch/feed stream, pure feed stream processes or feed stream processes onto nucleating particles.

Emulsifiers may be employed to facilitate polymerization of the copolymer. Emulsifiers used are generally nonionic emulsifiers, ionic emulsifiers or combinations of nonionic with ionic emulsifiers, The amount of emulsifiers, based on the total amount of monomers employed, is typically up to about 10 wt. %, in some embodiments from about 0.1 wt. % to about 6.0 wt. %, and in some embodiments, from about 0.5 wt. % to about 5.0 wt. %. Examples of nonionic emulsifiers are acyl, alkyl, oleyl, and alkylaryl oxyethylates. These products are available commercially, for example, under the name Genapol® M, Emulsogen® or Lutensol® and include, for example, ethoxylated mono-, di-, and tri-alkylphenols (ethylene oxide degree: 3 to 80, alkyl substituent radical: C₄ to C₁₂) and also ethoxylated fatty alcohols (ethylene oxide degree: 3 to 80; alkyl radical: C₈ to C₃₆), especially C₁₂-C₁₄ fatty alcohol ethoxylates, C₁₃C₁₅ oxo-process alcohol ethoxylates, C₁₆-C₁₈ fatty alcohol ethoxylates, C₁₀ oxo-process alcohol ethoxylates, C₁₃ oxo-process alcohol ethoxylates, polyoxyethylenesorbitan monooleate with 20 ethylene oxide groups, copolymers of ethylene oxide and propylene oxide with a minimum ethylene oxide content of 10% by weight, the polyethylene oxide ethers of oleyl alcohol, and the polyethylene oxide ethers of nonylphenol. Instead of or in addition to nonionic emulsifiers it is possible to use ionic emulsifiers (e.g., anionic emulsifiers). Examples include sodium, potassium, and ammonium salts of straight-chain aliphatic carboxylic acids of chain length C₁₂-C₂₀, sodium hydroxyoctadecanesulfonate, sodium, potassium, and ammonium salts of hydroxy-fatty acids of chain length C₁₂-C₂₀ and their sulfonation and/or acetylation products, alkyl sulfates, also in the form of triethanolamine salts, alkyl(C₁₀-C₂₀)-sulfonates, alkyl(C₁₀-C₂₀)-arylsulfonates, dimethyldialkyl(C₈-C₁₈)-ammonium chloride, and their sulfonation products, alkali metal salts of sulfosuccinic esters with aliphatic saturated monohydric alcohols of chain length C₄-C₁₆, 4-sulfosuccinic esters with polyethylene glycol ethers of monohydric aliphatic alcohols of chain length C₁₀-C₁₂ (di-sodium salt), 4-sulfosuccinic esters with polyethylene glycol nonylphenyl ether (di-sodium salt), sulfosuccinic acid biscyclohexyl ester (sodium salt), lignosulfonic acid and its calcium, magnesium, sodium, and ammonium salts, resin acids, hydrogenated and dehydrogenated resin acids, and also their alkali metal salts, dodecylated sodium diphenyl ether disulfonate, and also sodium lauryl sulfate, or ethoxylated sodium lauryl ether sulfate, or sodium dodecylbenzene sulfonate. Mixtures of ionic emulsifiers can also be used.

Protective colloids may also be employed as a polymeric stabilizer Examples thereof are polyvinyl alcohols; polyvinyl acetals; polyvinylpyrrolidones; polysaccharides in water-soluble form, such as starches (amylose and amylopectin), modified starches, celluloses and their carboxymethyl, methyl, hydroxyethyl, and hydroxypropyl derivatives; proteins, such as casein or caseinate, soy protein, gelatin; lignosulfonates; synthetic polymers such as poly(meth)acrylic acid, copolymers of (meth)acrylates with carboxyl-functional comonomer units, poly(meth)acrylamide, polyvinylsulfonic acids, and water-soluble copolymers thereof; melamine-formaldehyde sulfonates, naphthalene-formaldehyde sulfonates, styrene-maleic acid copolymers and vinyl ether-maleic acid copolymers, or polyurethane stabilizers. A particularly suitable protective colloid is polyvinyl alcohol, which may possess a degree of hydrolysis of 60 to 100 mol %, preferably 70 to 99 mol %, and viscosities of the 4% strength aqueous solutions at 20° C. of 2-70 mPas, more particularly 30 to 60 mPas. Besides “homopolymeric” polyvinyl alcohol, i.e., polyvinyl alcohol composed only of vinyl alcohol groups and residual vinyl acetate groups, it is possible to use copolymeric and/or functionalized polyvinyl alcohols, examples being reaction products of polyvinyl alcohol with diketene or with types of polyvinyl alcohols that carry carboxyl groups, thiol groups, formamido groups, amino groups, arylamino groups, sulfate groups, sulfonate groups, phosphonate groups, quaternary ammonium groups, and other functional groups, such as partially acetalized polyvinyl alcohols. When employed, the total amount of protective colloids, based on the total amount of the monomers employed, may be up to about 1.0 wt. %, in some embodiments from about 0.01 wt. % to about 0.8 wt. %, and in some embodiments, from about 0.1 wt. % to about 0.6 wt. %.

To help initiate the polymerization reaction, it is possible to use a free-radical polymerization initiator. Examples of such are hydrogen peroxide, benzoyl peroxide, cyclohexanone peroxide, isopropylcumyl hydroperoxide, persulfates of potassium, of sodium, and of ammonium, peroxides of even-numbered saturated monobasic aliphatic carboxylic acids of chain length C₈-C₁₂, tert-butyl hydroperoxide, di-tert-butyl peroxide, diisopropyl percarbonate, acetyl cyclohexanesulfonyl peroxide, tent-butyl perbenzoate, tert-butyl peroctoate, bis(3,5,5-trimethylhexanoyl) peroxide, tert-butyl perpivalate, hydroperoxypinane, p-methane hydroperoxide, or azo initiators, such as azoisobutyrodinitrile or 2,2′-azobis(2-methylpropionamidino) dihydrochloride. The aforementioned compounds may also be used within a redox system, in which transition metal salts, such as iron(II)/(III) salts, or other reducing agents are used. Suitable reducing agents may include alkali metal salts of oxymethanesulfinic acid, such as sodium formaldehyde-sulfoxylate dihydrate (Rongalit® C) or a mixture of 2-hydroxy-2-sulfinateacetic acid disodium salt, 2-hydroxy-2-sulfonateacetic acid disodium salt, and sodium sulfite (Bruggolit® FF6 and Bruggolit® FF7), mercaptans of chain length C₁₀-C₁₄, but-1-ene-3-ol, hydroxylamine salts, sodium dialkyl dithiocarbamate, sodium bisulfite, ammonium bisulfite, sodium dithionite, diisopropylxanthogen disulfide, ascorbic acid, tartaric acid, isoascorbic acid, boric acid, urea, and formic acid.

In certain embodiments, light stabilizers can also be employed in the coating to help improve the lightfastness of a dye that is applied to the fibers. Without intending to be limited by theory, it is believed that when crosslinked, the emulsion copolymer coating can help disperse and encapsulate the light stabilizer around the fiber so that it is not easily removed or degraded. When employed, light stabilizers may constitute from about OA wt. % to about 10 wt. %, in some embodiments from about 0.2 wt. % to about 5 wt. %, and in some embodiments, from about 0.25 wt. % to about 4 wt. % of the polymer coating.

One particularly suitable light stabilizer that may be employed is a hindered amine light stabilizer (“HALS”). Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. The hindered amine may, for example, be an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit. One particularly suitable high molecular weight hindered amine is commercially available from Clariant under the designation Hostavin® N30 (number average molecular weight of 1200). Another suitable high molecular weight hindered amine is commercially available from Adeka Palmarole SAS under the designation ADK STAB® LA-63 and ADK STAB® LA-68. Yet other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl)(2,2,6,6-tetramethyl-4-piperidinyl)-inninohexamethylene-(2,2,6,6-tetramethyl-4-piperidinyl)-imino) (Cyasorb® UV 3346 from Cytec, MW=1600); polymethylpropyl-3-oxy-[4(2,2,6,6-tetramethyl)-piperidinylysiloxane (Uvasil® 299 from Great Lakes Chemical, MW=1100 to 2500); copolymer of a-methylstyrene-N-(2,2,6,6-tetramethyl-4-piperidinyl)maleimide and N-stearyl maleimide; 2,4,8,10-tetraoxaspiro[5.5]undecane-3,9-diethanol tetramethyl-polymer with 1,2,3,4-butanetetracarboxylic acid; and so forth. Still other suitable high molecular weight hindered amines are described in U.S. Pat. Nos. 5,679,733 to Malik, et al. and 6,414,155 to Sassi, et al.

In addition to the high molecular hindered amines, low molecular weight hindered amines may also be employed. Such hindered amines are generally monomeric in nature and have a molecular weight of about 1000 or less, in some embodiments from about 155 to about 800, and in some embodiments, from about 300 to about 800. Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl) sebacate; 8-acetyl-3-dodecyl-7,7,9,9-tetramethyl-1,3,8-triazaspiro-(4,5)-decane-2,4-dione; butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; O-alanine, N-(2,2,6,6-tetramethyl-4-piperidinyl), dodecylester; ethanediamide, N-(1-acetyl-2,2,6,6-tetramethyipiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione; (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl) propionylamide; 1,2-bis-(3,3,5,5-tetrannethyl-2-oxo-piperazinyl) ethane; 4-oleoyloxy-2,2,6,6-tetramethylpiperidine; and combinations thereof. Other suitable low molecular weight hindered amines are described in U.S. Pat. Nos. 5,679,733 to Malik, et al.

Other suitable light stabilizers may include UV absorbers, such as benzotriazoles or benzopheones, which can absorb ultraviolet light energy.

Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyl-oxypropyl)phenyl]benzotriazole; and combinations thereof. Exemplary benzophenone light stabilizers may likewise include 2-hydroxy-4-dodecyloxybenzophenone; 2,4-dihydroxybenzophenone; 2-(4-benzoyl-3-hydroxyphenoxy) ethyl acrylate (Cyasorb® UV 209 from Cytec); 2-hydroxy-4-n-octyloxy)benzophenone (Cyasorb® 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-Cert-butylphenyl) ester (Cyasorb® 712 from Cytec); 4,4′-dimethoxy-2,2′-dihydroxybenzophenone (Cyasorb® UV 12 from Cytec); and combinations thereof.

When employed, light stabilizers, emulsifiers, protective colloids, initiators, reducing agents, etc. may be introduced at the beginning of the polymerization, or included partly in the initial charge and partly metered in, or metered in completely during the implementation of the polymerization. The metering may take place separately or together with at least one monomer in the form of a monomer emulsion. Residual monomer can also be removed following the end of the polymerization, using known methods, by postpolymerization, generally by means of postpolymerization initiated using redox systems. Volatile residual monomers may also be removed by means of distillation, typically under reduced pressure, and, where appropriate, with inert entraining gases such as air, nitrogen or steam passed through or over the product.

The resulting emulsion may possess a solids contents of from about 20 wt. % to about 70 wt. %, in some embodiments from about 30 wt. % to about 65 wt. %, and in some embodiments, from about 40 wt. % to about 60 wt. %. Likewise, the concentration of the solvents employed in the emulsion (e.g., water) is typically from about 30 wt. % to about 80 wt. %, in some embodiments from about 35 wt. % to about 70 wt. %, and in some embodiments, from about 40 wt. % to about 60 wt. % of the coating solution. The pH of the emulsion may range from about 2 to about 8, and in some embodiments, from about 4 to about 7. The copolymer also typically has a glass transition temperature of about 70° C. or less so that the flexibility of the fibers is not substantially restricted. Moreover, the polymer also typically has a glass transition temperature of about −50° C. or more to minimize tackiness. In some embodiments, the copolymer has a glass transition temperature from about 30° C. to about 30° C., and in some embodiments, from about −15° C. to about 15° C.

The nature of the fibers that are coated with the emulsion copolymer may vary. For example, individual fibers (e.g., staple fibers or continuous filaments) can be coated with the emulsion copolymer. Likewise, the fibers may initially be formed into a yarn, fabric, or article (e.g., garment) and then coated with the emulsion copolymer. Regardless, the emulsion may be applied using any conventional technique, such as bar, roll, knife, curtain, print (e.g., rotogravure), spray, slot-die, drop-coating, or dip-coating techniques. In certain cases, it may be desired to further dilute the emulsion with a solvent (e.g., water) to form a treatment bath. In one embodiment, for example, yarn can be treated with a diluted bath using a nip roll squeeze after each bath saturation. Yarn can also be treated in “package” form with the bath. Woven fabrics can likewise be finished with a bath in a continuous stenter (open width) frames or with batch processes such as, piece dyeing, jet, beck, jigger or paddle machines. Knit fabrics can be processed in the same machinery (both continuous and batch) as woven fabrics, just under different conditions. For garments, industrial garment washing machines may be used. Optional application methods include manual processes, such as spraying or manual wet add-on techniques. In another embodiment, fibers can be treated on a continuous immersion apparatus, such as described in U.S. Pat. No. 4,920,621. In one particular embodiment, the fibers can be contacted with the emulsion copolymer-containing treatment bath in a continuous padding operation run at a pad pressure of from about 0.3 bar to about 2.5 bar, and in some embodiments, from about 0.4 bar to about 1.5 bar.

Once applied, the treated fibers are heated to a certain temperature to initiate a crosslinking reaction of the emulsion copolymer (or cure) in the manner described above. Curing conditions may involve subjecting copolymer to a temperature of from about 100° C. to about 200° C., in some embodiments from about 120° C. to about 170° C., and in some embodiments, from about 140° C. to about 165° C. The dwell time for curing may vary, but is typically from about 0.1 to about 30 minutes, in some embodiments from about 0.2 to about 10 minutes, and in some embodiments, from about 0.3 to about 2 minutes. In addition to initiating a crosslinking reaction, curing can also serve to partially or even substantially completely dry the fibers. In certain embodiments, for example, the cured fibers are anhydrous, i.e., generally free of water.

The solids add-on level of the emulsion treated fibers may vary and may depend on a variety of factors, such as the desired depth of shade of a dye subsequently applied thereto. The “solids add-on level” is determined by subtracting the weight of the untreated fibers from the weight of the emulsion treated fibers (after curing), dividing this calculated weight by the weight of the untreated fibers, and then multiplying by 100%. Lower add-on levels may optimize certain properties (e.g., flexibility), while higher add-on levels may optimize the ability of the fibers to receive a dye. In some embodiments, for example, the solids add-on level is from about 0.01% to about 50%, in some embodiments from about 0.05% to about 10%, and in some embodiments, from about 0.1% to about 5%. The coating may cover an entire surface of the fibers, or may only cover a portion of the surface. One benefit of the present invention, however, is that the emulsion copolymer can cover substantially all of the fiber surface, resulting in a more uniform coating for receiving the dye.

III. Treatment with Additives

As indicated above, one benefit provided by the emulsion copolymer-treated fibers of the present invention is that they can be readily applied with disperse additives, such as light stabilizers, dyes, etc. In one embodiment, for example, the emulsion copolymer-coated fibers can be treated with a light stabilizer, such as described above. As noted above, the present inventors believe that when crosslinked, the emulsion copolymer coating can help disperse and encapsulate the light stabilizer around the fiber so that it is not easily removed or degraded.

Likewise, the fibers can also be subjected to one or more dyeing operations in which the fibers are contacted with a disperse dye. Suitable disperse dyes may include those described in “Disperse Dyes” in the Color Index, 3^{rd} edition. Such dyes include, for example, carboxylic acid group-free and/or sulfonic acid group-free nitro, amino, aminoketone, ketoninime, methine, polymethine, diphenylamine, quinoline, benzimidazole, xanthene, oxazine and coumarin dyes and especially anthraquinone and azo dyes, such as mono- or di-azo dyes. Disperse dyes are also described in detail in U.S. Patent Publication No. 2006/0048308. For instance, primary red color disperse dyes may include Disperse Red 60 (Intrasil Brilliant Red 2B 200%), Disperse Red 50 (Intrasil Scarlet 2GH), Disperse Red 146 (Intrasil Red BSF), Disperse Red 127 (Dianix Red BSE), Dianix Red ACE, Disperse Red 65 (Intrasil Red MG), Diperse Red 86 (Terasil Pink 2 GLA), Disperse Red 191 (Intrasil Pink SRL), Disperse Red 338 (Intrasil Red 4BY), Disperse Red 302 (Tetrasil Pink 3G), Disperse Red 13 (Intrasperse Bordeaux BA), Disperse Red 167 (Foron Rubine S-2GFL), Disperse Violet 2 (Intrasil Violet FRL), etc.; primary blue color disperse dyes may include Disperse Blue 60 (Terasil Blue BGE 200%), Disperse Blue 291 (Intrasil Blue MGS), Disperse Blue 118 (Terasil Blue GBT), Terasil Blue HLB, Dianix Blue ACE, Disperse Blue 87 (Intrasil Blue FGB), Disperse Blue 148 (Palanil Dark blue 3RT), Disperse Blue 56 (Intrasil Blue FBL), Disperse Blue 332 (Bafixan Turquoise 2 BL liq.), etc.; and primary yellow color dyes may include Disperse Yellow 64 (Disperite Yellow 3G 200%), Disperse Yellow 23 (Intrasil Yellow 5R), Palanil Yellow HM, Disperse Brown 19 (Dispersol Yellow D-7G), Disperse Orange 30 (Foron Yellow Brown S-2RFL), Disperse Orange 41 (Intrasil Orange 4RL), Disperse Orange 37 (Intrasil Dark Orange 3GH), Disperse Yellow 3, Disperse Orange 30, Disperse Yellow 42, Disperse Orange 89, Disperse Yellow 235, Disperse Orange 3, Disperse Yellow 54, Disperse Yellow 233 (Foron Yellow S-6GL), etc.

The copolymer-treated fibers may be contacted with the disperse additive by immersing them in a bath (e.g., aqueous bath) that contains the additive. The additive-containing bath can be the same or different than the bath used to apply the emulsion copolymer coating. In certain embodiments, for example, a sequential process is employed in which the fibers are first coated with the emulsion copolymer, dried, and then treated with an additive. The weight ratio of the dye bath to the fabric (also known as the “liquor ratio”) is typically from about 5 to about 30, in some embodiments from about 8 to about 25, and in some embodiments, from about 10 to about 20. Regardless, disperse additives typically constitute, for example, from about 0.01 wt. % to about 15 wt. %, and in some embodiments, from about 0.5 wt. % to about 5 wt. %. of the bath in which it is employed. For example, lower concentrations of a dye in are useful for tinting operations, while higher dye concentrations produce a more intense color. Other components may also be employed in the additive bath, such as surfactants, optical brighteners, fabric softeners, antistatic agents, antibacterial agents, anti-wrinkling agents, ironing aids, flame-retardants, enzymes, anti-foaming agents, fragrances, etc. The additive bath is generally contacted with the fibers at temperatures of from about 15° C. to about 150° C., in some embodiments from about 20° C. to about 130° C., and in some embodiments, from about 20° C. to about 80° C. Under such temperature conditions, application of the additive (e.g., dye) can still be readily carried out at atmospheric pressure. The pH of the bath is also typically in the range of from about 3 to about 8, and in some embodiments, from about 4 to about 7. Application of the additive may be carried out using either batch or continuous operations. If a batch method is employed, the copolymer-treated fibers are typically contacted with the bath for a period of from about 0.25 to about 3 hours, and in some embodiments, from about 0.5 to about 1.0 hour.

When dyed, the color of the dyed fibers may be substantially different than the original fibers, even after laundering and/or aging in ultraviolet violet for a certain period of time (e.g., 20 hours), due in part to the ability of the coating to physically entrap the dye. This difference in color can be quantified by measuring the absorbance with an optical reader in accordance with a standard test methodology known as “CIELAB”, which is described in Pocket Guide to Digital Printing by F. Cost, Delmar Publishers, Albany, N.Y. ISBN 0-8273-7592-1 at pages 144 and 145 and “Photoelectric color difference meter”, Journal of Optical Society of America, volume 48, page numbers 985-995, S. Hunter, (1958), both of which are incorporated herein by reference in their entirety. More specifically, the CIELAB test method defines three “Hunter” scale values, L*, a*, and b*, which correspond to three characteristics of a perceived color based on the opponent theory of color perception and are defined as follows:

L*=Lightness (or luminosity), ranging from 0 to 100, where 0=dark and 100=light;

a*=Red/green axis, ranging from −100 to 100; positive values are reddish and negative values are greenish; and

b*=Yellow/blue axis, ranging from −100 to 100; positive values are yellowish and negative values are bluish.

Color measurement can be performed using a DataColor 650 Spectrophotometer utilizing an integrating sphere with measurements made using the specular included mode. Color coordinates can likewise be calculated according to ASTM D2244-11 under an illuminant D65/10°, A/10°, or F2/10° observer, using CIELAB units. Because CIELAB color space is somewhat visually uniform, a single number may be calculated that represents the total absolute color difference between two colors as perceived by a human using the following equation:

ΔE=[(ΔL^{*})²_{+(Δ}a²+(Δb^{*})²]^{1/2}

wherein, ΔL^{*} is the luminosity value of a first color subtracted from the luminosity value of a second color, Δa^{*} is the red/green axis value of the first color subtracted from the red/green axis value of the second color; and Δb^{*} is the yellow/blue axis value of the first color subtracted from the yellow/blue axis value of the second color. In CIELAB color space, each AE unit is approximately equal to a “just noticeable” difference between two colors and is therefore a good measure for an objective device-independent color specification system that may be used for the purpose of expressing differences in color. For instance, the “first color” in the formula above may represent the color of the undyed fibers and the “second color” may represent the color of the dyed fibers. In the present invention, the resulting AE values may be relatively large, such as about 5 or more, in some embodiments about 10 more, and in some embodiments, about 20 more. The dyed fibers may possess, for instance, a lightness (L^{*}) of 50 to 120, a green-red (a^{*}) of −20 to 20, and a blue-yellow (b^{*}) of −20 to 20. Notably, such ΔE values may even be maintained after exposure of the materials to ultraviolet light for a certain period of time, such as about 20 hours.

### IV. Articles

The fabric of the present invention may generally be employed in a wide variety of different articles. For example, due to the heat resistance of polyarylene sulfides, the fabric may be particularly well suited in articles in which flame retardancy and/or chemical resistance is desired. Such articles may include, for instance, protective garments, gloves, aprons, coveralls, boots, hoods, sleepware, etc. For example, a garment that protects firefighters against heat, flame and electric arc in fighting structural fires is known as a “turnout” coat. Such coats may be formed from one or multiple layers, such as a thermal liner that faces the wearer, an outer shell, a moisture barrier positioned between the thermal liner and outer shell. Any layer of the coat may contain the fabric of the present invention. Regardless of the particular types of articles in which it is employed, the fabric of the present invention may exhibit flame retardant properties without the need for conventional flame retardants, such as phosphoric compounds (e.g., phosphinic acid salts), nitrogen-containing synergists (e.g., melamine, melamine cyanurate, etc.), and so forth. In fact, the fabric can be substantially free of flame retardants in that they constitute no more than about 5 wt. %, in some embodiments no more than about 2 wt. %, and in some embodiments, no more than about 0.5 wt. % of the fabric. Of course, it should be understood that in certain alternative embodiments, flame retardants may be employed in higher percentages if desired.

The present invention may be better understood with reference to the following examples.

### EXAMPLE 1

A bath of 50% solids acrylic emulsion (containing 86 parts ethyl acrylate, 8 parts of acrylonitrile, and 5.9 parts N-methylolacrylamide (NMA)) is made to a 10% solution by diluting 1 liter of the acrylic emulsion in 4 liters of water. A woven PPS/cotton blend fabric is passed through the bath to saturate the fabric before it is pressed. The fabric is then passed through a padder with a 0.5 bar pressure to remove excess bath solution and dried in a Mathis LTF oven at a temperature of 95° C. to 105° C. Subsequently, the fabric is cured at 150° C. for 30 seconds to 4 minutes in a Mathis LTF oven. The percent wet pick up is between 150% to 200% and the percent solids add-on level is 5%. Once pretreated with the emulsion coating, a disperse dye formulation is then applied. The dye formulation contains Terasil NFR (Navy), which is a blended dye chemistry available from Huntsman International, LLC (at 2.5% on weight of goods (owg)). The fabric is treated with the dye formulation in a batch or exhaust dyeing operation in which the liquor ratio is 20 parts bath to 1 part fabric. The temperature of the bath is increased from 27° C. at a ramp rate of 2° C./min. The temperature is held for 60 minutes once 135° C. is reached. The bath is then cooled to 40° C. and dropped. The fabric is thereafter rinsed in an over flow wash to remove excess dye and then dried at 60° C. for 10 minutes. Color measurements were then performed as described above. The dyed samples had CIELAB values of: L*: 32.6, a*: 3.87, b*: −3.66.

### EXAMPLE 2

A bath of 5% acrylic emulsion (consisting of 86 parts ethyl acrylate, 8 parts of acrylonitrile, and 5.9 parts N-methylolacrylamide (NMA)) solids & 4% UV absorber (commercially available “UV Fast-P” from Huntsman International LLC or “Fadex-F” from Clariant International Ltd.) is made by mixing 100 grams of emulsion and 40 grams of UV absorber into 860 ml of water. A woven PPS/cotton blend fabric is then passed through a padder with a 0.5 bar pressure to remove excess bath solution and dried in a Mathis LTF oven at a temperature of 95° C. to 105° C. Subsequently, the fabric is cured at 150° C. for 6 minutes in a Mathis LTF oven. The percent wet pick up is between 150% to 200% and the percent solids add-on level is 9%. Once pretreated with the emulsion coating, the disperse dye formulation of Example 1 is then applied. The dye formulation contains Terasil NFR (NAVY), which is a blended dye chemistry available from DyStar L.P. (at 2.5% on weight of goods (owg)). The fabric is treated with the dye formulation in a batch or exhaust dyeing operation in which the liquor ratio is 20 parts bath to 1 part fabric. The temperature of the bath is increased from 27° C. at a ramp rate of 2° C./min. The temperature is held for 60 minutes once 130° C. is reached. The bath is then cooled to 40° C. and dropped. The fabric is thereafter rinsed in an over flow wash to remove excess dye and then dried at 60° C. for 10 minutes. Color measurements were then performed as described above, before and after 20 hours of UV exposure. The samples (before UV exposure) had CIELAB values of: L*: 24.95, a*: 0.86, b*: −2.88, and the samples (after UV exposure) had CIELAB values of: L*: 23.81, a*: 0.87, b*: 0.39.

### EXAMPLE 3

A bath is made by mixing 100 grams of a 5% acrylic emulsion (Hycar 2679, Lubrizol) and 40 grams of a 4% UV absorber (commercially available “UV Fast-P” from Huntsman International LLC or “Fadex-F” from Clariant International Ltd.) into 860 milliliters of water. A woven PPS/cotton fabric is passed through a bath of 50% solids acrylic emulsion (Hycar 2679, Lubrizol) to saturate the fabric before it is pressed. The fabric is then passed through a padder with a 0.5 bar pressure to remove excess bath solution and dried in a Mathis LTF oven at a temperature of 95° C. to 105° C. Subsequently, the fabric is cured at 150° C. for 6 minutes in a Mathis LTF oven. The percent wet pick up is between 150% to 200% and the solids add-on level is 9%. Once pretreated with the emulsion coating, a dye formulation is applied that contains Terasil NFR (Navy), which is a blended dye chemistry available from Huntsman International, LLC (at 1.0% on weight of goods (owg)). More particularly, the fabric is treated with the dye formulation in a batch or exhaust dyeing operation in which the liquor ratio is 20 parts bath to 1 part fabric. The temperature of the bath is increased from 27° C. at a ramp rate of 3° C./min. The temperature is held for 60 minutes once 130° C. is reached. The bath is then cooled to 40° C. and dropped. The fabric is thereafter rinsed in an over flow wash to remove excess dye and then dried at 60° C. for 10 minutes. Color measurements were then performed as described above, before and after 20 hours of UV exposure. The samples (before UV exposure) had CIELAB values of: L*: 25.12, a*: 1.43, b*: −4.34, and the samples (after UV exposure) had CIELAB values of: L*: 24.91, a*: 1.41, b*: −3.17.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A fabric that comprises textile fibers and polyarylene sulfide fibers formed from at least one polyarylene sulfide, wherein an emulsion copolymer is disposed on the textile fibers, polyarylene sulfide fibers, or a combination thereof, the emulsion copolymer containing two or more ethylenically unsaturated monomeric units, wherein the emulsion copolymer is cured so as to form a three-dimensional crosslinked network that coats the fibers.

2. The fabric of claim 1, wherein the polyarylene sulfide is polyphenylene sulfide.

3. The fabric of claim 1, wherein the textile fibers include natural fibers.

4. The fabric of claim 3, wherein the natural fibers include cotton.

5. The fabric of claim 1, wherein the textile fibers include synthetic fibers selected from the group consisting of aromatic polyamides, aliphatic polyamides, polyesters, polybenzimidazole, polybenzoxazole, polypyridobisimidazole, rayon, melamine, acetate, lyocell, or a combination thereof.

6. The fabric of claim 1, wherein the ethylenically unsaturated monomeric units include vinyl esters, a-olefins, acrylic esters, styrenes, conjugated dienes, halogenated compounds, acrylonitrile, or combinations thereof.

7. The fabric of claim 1, wherein the copolymer is a vinyl acetate copolymer, vinyl chloride copolymer, acrylic copolymer, or a combination thereof.

8. The fabric of claim 1, wherein the emulsion copolymer is an acrylic ester copolymer.

9. The fabric of claim 8, wherein the acrylic ester copolymer contains from about 50 wt. % to about 99 wt. % of soft acrylic ester monomeric units and from about 1 wt. % to about 15 wt. % of hard monomeric units.

10. The fabric of claim 1, wherein the emulsion copolymer is a vinyl ester copolymer.

11. The fabric of claim 10, wherein the vinyl ester copolymer contains from about 60 wt. % to about 99 wt. % of vinyl ester monomeric units and from about 1 wt. % to about 30 wt. % of α-olefin monomeric units.

12. The fabric of claim 1, wherein the emulsion copolymer further comprises a crosslinkable co-monomer.

13. The fabric of claim 1, wherein a disperse dye is retained by the crosslinked network of the emulsion copolymer.

14. The fabric of claim 13, wherein the disperse dye is a carboxylic acid group-free and sulfonic acid group-free nitro dye, amino dye, aminoketone dye, ketoninime dye, methine dye, polymethine dye, diphenylamine dye, quinolone dye, benzimidazole dye, xanthene dye, oxazine dye, coumarin dye, anthraquinone dyes, azo dye, or a combination thereof.

15. The fabric of claim 1, wherein a light stabilizer is retained by the crosslinked network of the emulsion copolymer.

16. The fabric of claim 1, wherein the emulsion copolymer is disposed on the polyarylene sulfide fibers.

17. The fabric of claim 1, wherein the fabric contains multi-filament yarns that include the textile fibers and the polyarylene sulfide fibers.

18. The fabric of claim 1, wherein the fabric contains a first set of yarns that contain the textile fibers and a second set of fibers that contain the polyarylene sulfide fibers.

19. A garment comprising the fabric of claim 1.

20. The garment of claim 19, wherein the garment is a turnout coat containing a thermal liner, an outer shell, and a moisture barrier positioned between the liner and the outer shell, wherein the fabric is incorporated in the liner, outer shell, moisture barrier, or a combination thereof.

21. A fabric that comprises a first set of yarns that contain cotton fibers and a second set of yarns that contain polyphenylene sulfide fibers, wherein an emulsion copolymer is disposed on the polyphenylene sulfide fibers, the emulsion copolymer containing two or more ethylenically unsaturated monomeric units, wherein the emulsion copolymer is cured so as to form a three-dimensional crosslinked network that coats the polyphenylene sulfide fibers.

22. The fabric of claim 21, wherein the ethylenically unsaturated monomeric units include vinyl esters, α-olefins, acrylic esters, styrenes, conjugated dienes, halogenated compounds, acrylonitrile, or combinations thereof.

23. The fabric of claim 21, wherein the copolymer is a vinyl acetate copolymer, vinyl chloride copolymer, acrylic copolymer, or a combination thereof.

24. The fabric of claim 21, wherein the emulsion copolymer is an acrylic ester copolymer.

25. The fabric of claim 24, wherein the acrylic ester copolymer contains from about 50 wt. % to about 99 wt. % of soft acrylic ester monomeric units and from about 1 wt. % to about 15 wt. % of hard monomeric units.

26. The fabric of claim 21, wherein the emulsion copolymer is a vinyl ester copolymer.

27. The fabric of claim 26, wherein the vinyl ester copolymer contains from about 60 wt. % to about 99 wt. % of vinyl ester monomeric units and from about 1 wt. % to about 30 wt. % of α-olefin monomeric units.

28. The fabric of claim 21, wherein the emulsion copolymer further comprises a crosslinkable co-monomer.

29. The fabric of claim 21, wherein a disperse dye is retained by the crosslinked network of the emulsion copolymer.

30. The fabric of claim 21, wherein a light stabilizer is retained by the crosslinked network of the emulsion copolymer.

31. A method for dyeing a fabric that comprises textile fibers and polyarylene sulfide fibers formed from at least one polyarylene sulfide, the method comprising:
contacting the fabric with an aqueous emulsion comprising a copolymer that contains two or more ethylenically unsaturated monomeric units;
curing the emulsion copolymer to form a three-dimensional crosslinked network that coats the textile fibers and the polyarylene sulfide fibers; and
immersing the fabric in a bath that contains a disperse dye.

32. The method of claim 31, wherein the polyarylene sulfide is polyphenylene sulfide.

33. The method of claim 31, wherein the copolymer is an acrylic ester copolymer.

34. The method of claim 31, wherein the copolymer is a vinyl ester copolymer.

35. The method of claim 34, wherein the vinyl ester copolymer contains from about 60 wt. % to about 99 wt. % of vinyl ester monomeric units and from about 1 wt. % to about 30 wt. % of α-olefin monomeric units.

36. The method of claim 31, wherein the emulsion copolymer further comprises a crosslinkable co-monomer.

37. The method of claim 31, wherein the emulsion has a solids content of from about 20 wt. % to about 70 wt. %.

38. The method of claim 31, wherein the emulsion has a pH of from about 2 to about 8.

39. The method of claim 31, wherein the emulsion further comprises an emulsifier, protective colloid, free-radical polymerization initiator, light stabilizer, reducing agent, or a combination thereof.

40. The method of claim 31, wherein the copolymer is cured at a temperature of from about 100° C. to about 200° C.

41. The method of claim 31, wherein the dye bath further comprises a light stabilizer.

42. The method of claim 31, wherein the disperse dye is a carboxylic acid group-free and sulfonic acid group-free nitro dye, amino dye, aminoketone dye, ketoninime dye, methine dye, polymethine dye, diphenylamine dye, quinolone dye, benzimidazole dye, xanthene dye, oxazine dye, coumarin dye, anthraquinone dyes, azo dye, or a combination thereof.
